(19) United States
(12) Patent Application Publication
(10) Pub. No.: US 2021/0080090 A1
(43) Pub. Date: Mar. 18, 2021

(54) EXTENDIBLE COILED MEMBER AND RELATED METHODS

(71) Applicant: RTL Materials Ltd., Lymington Hampshire (GB)

(72) Inventor: Andrew Daton-Lovett, Lymington (GB)

(21) Appl. No.: 16/772,398

(22) PCT Filed: Dec. 18, 2018
(86) PCT No.: PCT/GB2018/053671

§ 371 Date: Jun. 12, 2020

(30) Foreign Application Priority Data
Dec. 18, 2017 (GB) 1721203.6

(51) Int. Cl. F21V 21/14; B32B 7/022; B32B 7/12; B32B 7/03; B32B 27/08; F21V 21/08

(52) U.S. Cl. CPC F21V 21/14; B32B 7/022; B32B 7/12; B32B 7/03; B32B 27/08; B32B 2457/08; B32B 2307/414; B32B 2457/206; B32B 2260/021; B32B 2260/046; B32B 2307/50; F21V 21/0816

(57) ABSTRACT

The application relates to member extendible from a coiled form, a method of deploying a device, a method of manufacturing a member and to a bistable reelable composite slit tube extendible member. In an aspect, there is provided a member (10) comprising a first layer or layers 11 exhibiting a high Poisson's ratio, an inextensible layer (30) fixed to the first layer or layers, and a device (40) fixed to or incorporating the inextensible layer. The member when extended from a coiled form is resiliently biased in a form having a curved cross section transverse to the direction of extension. Incorporating the inextensible layer (30) in this way has the effect of moving the neutral axis of the overall member towards that layer, such that the device attached to that layer experiences greatly reduced shear stresses.

### CROSS REFERENCE TO RELATED APPLICATIONS

This application is a national phase filing under 35 U.S.C. § 371 of International Patent Application No. PCT/GB2018/053671, filed Dec. 18, 2018, which claims the benefit of British Patent Application No. 1721203.6, filed Dec. 18, 2017, each of which is incorporated by reference in its entirety herein.

### TECHNOLOGY FIELD

The present invention relates to a member extendible from a coiled form, a method of deploying a device, a method of manufacturing a member and to a bistable reelable composite slit tube extendible member.

### BACKGROUND

The use of curved “tapes” that are coiled to compact them into a small, rolled form for transport or as part of their use goes back to the carpenter's tape measure. In the 1950's this idea was extended by Joseph Rimrott and others to form the Slit (or Storable) Tubular Extendible Member, referred to as a STEM. This was formed in the same manner as the tape measure but with the extended section formed to subtend an arc closer to 360 degrees. The general form of such STEMs is shown in FIG. 1. A discussion of STEM technology is given in Rimrott F. P. J., Fritzsche G. (2000) Fundamentals of STEM Mechanics. In: Pellegrino S., Guest S. D. (eds) IUTAM-IASS Symposium on Deployable Structures: Theory and Applications. Solid Mechanics and Its Applications, vol 80. Springer, Dordrecht.

In the 1990's, Andrew Daton-Lovett demonstrated a new class of STEM, where the materials used had high Poisson's ratios, such that the act of opening out the extended STEM, FIG. 1, in order to roll it along its length gave rise to Poisson's ratio derived forces that acted to cause the STEM to naturally coil towards the rolled form and so increase its stability in that form. If these forces are high enough the coiled form takes on a stable geometry, allowing the coiled device to be stored and transported without any form of constraint being needed to prevent it extending and making the act of coiling and uncoiling far easier, as the rolling load is reduced with respect to the stiffness of the extended device and the absence of any tendency of the coil to bloom, where the layers of the coil all attempt to open simultaneously, makes the design of mechanical drives that use this type of STEM as say an extendible arm far simpler. Examples are given in the international patent applications: WO A 88/08620, WO-A 97/35706, WO-A 99/62811, and WO-A 99/62812.

This new class of STEM is known to practitioners of the art as Bi-stable Reeled Composite, BRC.

BRCs are made in a range of subtended arcs, from overlapped extended sections down to tape-measure like relatively narrow sections, subtending perhaps as little as 30 or 40 degrees of arc.

BRCs are widely used, particularly in the provision of military antenna masts, inspection devices for nuclear generation plants and other hazardous environment facilities and in 2017 were first used successfully to provide booms in a space application, InflateSail, which successfully demonstrated de-orbiting of a satellite, a key step in developing solutions to the problem of debris in orbit.

One feature of BRCs well known to those working in the field is the difficulty of making anything stick to the surface of the device in such a manner as to survive repeated rolling and unrolling. A good and durable bond can be obtained with materials that are close to copying the high Poisson ratio behaviour of these surfaces, for example, RolaTube Technology Ltd manufacture antenna masts with an integrated antenna incorporated into the surface where the antenna conductive element is a copper mesh with the fibres oriented at 45 degree angles to the axis of extension. This mesh then follows the behaviour of the surface of the mast, ensuring that the shear strain that could result in the copper becoming unstuck from the mast is kept to an absolute minimum.

It is, however, desirable in some cases to be able to bond an element to the surface of a bi-stable structure that cannot behave in this manner but will experience a high shear stress at the bond line, such that it will prove difficult if not impossible to bond to the mast in such a manner as to survive repeated rolling and unrolling.

These shear stresses arise from the path difference between the surface of the bi-stable structure, which will first compress and then extend, or vice versa, depending on whether it is the inner or outer face prior to rolling.

In any structure that is being bent or coiled there is a line (when viewed in cross section and where the bending forces act on the structure in the plane of the cross section) that remains the same length during bending whilst material on either side of this line is either extended or compressed during bending. This line is known as the neutral axis of bending.

FIGS. 2A and 2B illustrate this effect. FIG. 2A shows an unbent material, with the neutral axis of bending 23 running along the interior of the material. This line is not necessarily coincident with the geometric centre. FIG. 2B shows the same material after being bent. The neutral axis of bending 23 remains the same length when bent. The intrados face 22 is compressed and thus shortening as the material is bent. The extrados face 21 is extended and thus lengthening as the material is bent.

In a material being coiled which has the extended form of a shell with a curved cross section, such as a STEM or BRC, these extensions and compressions occur in two directions on each face. The extrados face, for example, is first being compressed normal to the axis of extension as the extended STEM is transversely opened out into a flat form prior to coiling and then experiences an extension along the axis of extension as it is coiled. The process is inverted on the intrados face.

The shear stresses created make it difficult to bond devices to the surfaces of such a member. The present disclosure aims to address these and other problems in known devices.

### SUMMARY

In an aspect of the present invention, there is provided a member comprising: a first layer or layers exhibiting a high Poisson's ratio; an inextensible layer fixed to the first layer or layers; and a device fixed to or incorporating the inextensible layer, wherein the member when extended from a coiled form is resiliently biased in a form having a curved cross section transverse to the direction of extension.

Thus, a laminate is formed in which use of an inextensible layer controls the neutral axis of bending of the member to be at or close to the inextensible layer. The device is preferably flexible and thin, so the member can coil, but does not have a high Poisson's ratio. However, by being bonded to the inextensible member at or near the neutral axis, it experiences little or no shear forces at the bond to the inextensible layer and so forms a stronger, more resilient bond such that preferably the device experiences reduced strain and can tolerate multiple cycles of extension/coiling without failure. At the same time, the high Poisson's ratio layer or layers are spaced from the neutral axis and so, when the curved cross section is flattened out for coiling the member, it gives rise to forces in the material that tend to promote coiling of the member, providing a stable or more stable coiled form.

The member forms an elongate STEM, i.e. biased in the form of a slit tube, which in cross section may subtend any desired angle in its extended form, i.e. the longitudinal edges may overlap (the cross section subtends an angle of >360 degrees), meet (the cross section subtends an angle of 360 degrees), or leave a gap (the cross section subtends an angle of for example between 30 to 360 degrees). In some examples, the cross section may be only partially curved, e.g. having one or more straight portions with curved portions either side.

The Poisson's ratio of the high Poisson's ratio material is high relative to the Poisson's ratio of the device, meaning that ordinarily shear forces would arise if the layers were directly bonded, and also sufficient to give rise to the desired bistability in the member, making it easier to handle and deploy. The device is thin such that the member can coil. Typically, the member would have a thickness of between 2-10 mm.

Preferably the device is fixed to the inextensible layer on the opposite side of the inextensible layer to the first layer or layers. However, they could be on the same side, e.g. where the first layer or layers has one or more cut outs to accommodate the device or devices.

By controlling the position of the neutral axis a surface provided by the inextensible layer may also be made accessible for bonding the device to, where normally the neutral axis would be buried in the member, e.g. by providing the inextensible layer at a surface of the member or by providing cut-outs in outer layers to locally make accessible a surface of the inextensible layer for receiving a device.

In an embodiment, the device is a flexible display screen, lighting panel, or circuit board.

The member may comprise a wires, traces or contacts connecting to the device. These may be provided also on the inextensible sheet. Where the device is electrical, the member may comprise a connector attached to a convenient point on the member for supplying power or communicating data or control signals to and/or from the device.

In an embodiment the first layer or layers comprises a fibre reinforced composite with fibres angled to the axis of extension of the member.

In an embodiment, the inextensible layer is inextensible in one direction and extendible in the other surface direction.

This may be useful when the device is more tolerant to strains in one direction than the other, i.e. the less tolerant direction is aligned with the inextensible direction, such as discrete LEDs attached in runs that are predominantly aligned in one direction, where shear forces in that direction may cause circuit board traces to break or detach from the LEDs.

In an embodiment, wherein the member is inextensible in both, orthogonal surface directions.

In an embodiment, a flexible layer or second high Poisson's ratio layer or layers are bonded to the inextensible sheet on the opposite side to the first layer.

In an embodiment, wherein the flexible layer or second high Poisson's ratio layer or layers has a cut out to accommodate the device.

In an embodiment, the member comprises at least one translucent layer and the device is a light emitting device such that when extended, in use, light is visible external to the member through the translucent layer or layers on the intrados and/or extrados face of the member.

In an embodiment, the member in extended form is configured to form a stable bend at one or more points along its length.

The angle formed by extended portions either side of the bend is preferably between 10 and 120 degrees. Thus, the extended member can be formed into different shaped structures.

In an embodiment, the extended member in cross section has at least one flat portion adjacent at least one curved portion, wherein the device only extends across the flat portion.

Preferably, any flat portion is flanked by two curved portions, which exhibit bistability and help promote coiling of the member.

In another aspect, there is provided a method of deploying a device, using a member as described above, the method comprising: uncoiling the member; and positioning the member.

In an embodiment, the device comprises an electrical display, the method comprising, connecting a connector of the member to an external control device, computing device or power source.

In an embodiment, the method comprises forming a bend in the uncoiled member.

Thus, structures can be formed having 2D or 3D shapes, in contrast with a mainly 1-dimensional STEM. The ends of the STEM may be fastened together to provide stability to the structure.

In another aspect, there is provided a method of manufacturing a member, comprising laminating: a first layer or layers exhibiting a high Poisson's ratio; an inextensible layer fixed to the first layer or layers; and a device fixed to or incorporating the inextensible layer, wherein the member when extended from a coiled form is resiliently biased in a form having a curved cross section transverse to the direction of extension.

In an embodiment, the method comprises tensioning the high Poisson's ratio layer across its width, normal to the axis of extension, before laminating it to the inextensible layer such that the tension in the high Poisson's ratio layer will then bend the inextensible layer along the axis of extension.

In an embodiment, the method comprises laminating the first layer or layers to the inextensible layer before bonding the device to the rest of the member.

In another aspect, there is provided a bistable reeled composite STEM comprising a laminate of at least one fibre reinforced layer, having fibres angled to the extension direction, and an inextensible layer.

Thus preferred embodiments of the present invention address the design of bi-stable materials that have some or all of one face that exhibits very small extension or compression when bent or coiled, allowing flexible devices to be bonded to or formed as this surface without them being subjected to significant shear stresses during rolling and unrolling. It is anticipated that the invention will prove of utility for the provision of support structures that can be bent or coiled for flexible organic light emitting diode (OLED) lighting panels, flexible display screens, flexible printed circuit boards and other such devices where a means of providing structural support to a flexible device may be of use.

An aspect of the present invention consists of a thin, flexible sheet of material that is inextensible along the axis of extension, normal to it or along both, such as a thin metal or inextensible flexible polymer such as a Mylar or Kapton sheet, formed with a curved section along one axis as per the examples given of STEM type structures. This is then laminated on one face to a high Poisson ratio material, such as a fibre reinforced composite in which the fibres are at substantial angles to the axis of extension.

An aspect of the present invention provides a member comprising: a first layer or layers exhibiting a high Poisson's ratio; and an inextensible layer fixed to the first layer or layers; wherein the member when extended from a coiled form is resiliently biased in a form having a curved cross section transverse to the direction of extension and wherein the member in extended form is configured to form a stable bend at one or more points along its length.

It will be appreciated that any features expressed herein as being provided “in one example” or “in an embodiment” or as being “preferable” may be provided in combination with any one or more other such features together with any one or more of the aspects of the present invention. In particular, the extendible member, joining techniques and join testing system described in relation to one aspect may generally be applicable to the others.

### BRIEF DESCRIPTION OF THE DRAWINGS

Embodiments of the present invention will now be described by way of example with reference to the accompanying drawings, in which:

FIG. 1 shows a view of a conventional extendible reeled member;

FIGS. 2A and 2B show in cross section a member and the effect of applying a bending force to the member illustrating the location of the neutral axis of bending;

FIGS. 3A and 3B show in cross section examples of a slit tube extendible member according to an embodiment of the present invention;

FIGS. 4A and 4B show further examples of a slit tube extendible member according to an embodiment of the invention in which the member has more “tape” like form;

FIGS. 5 and 6 show examples of a slit tube extendible member having an attached panel;

FIGS. 7A and 7B show examples of a slit tube extendible member having bends at one or more positions along the length of the member; and,

FIG. 8 shows an example of a slit tube extendible member having a flat portion on which a panel is mounted.

### DETAILED DESCRIPTION OF ILLUSTRATIVE EMBODIMENTS

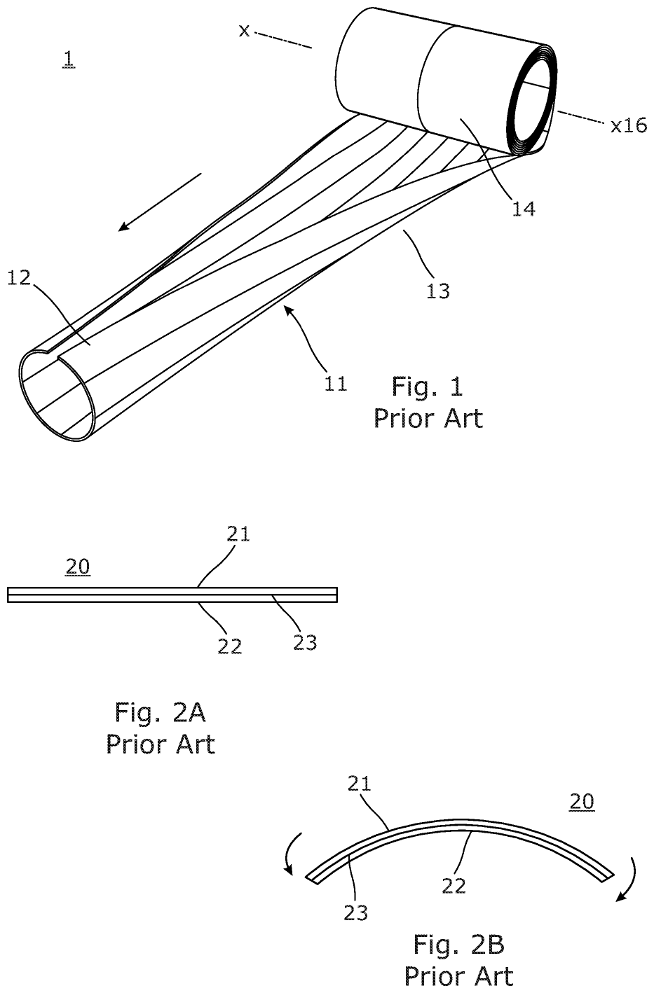

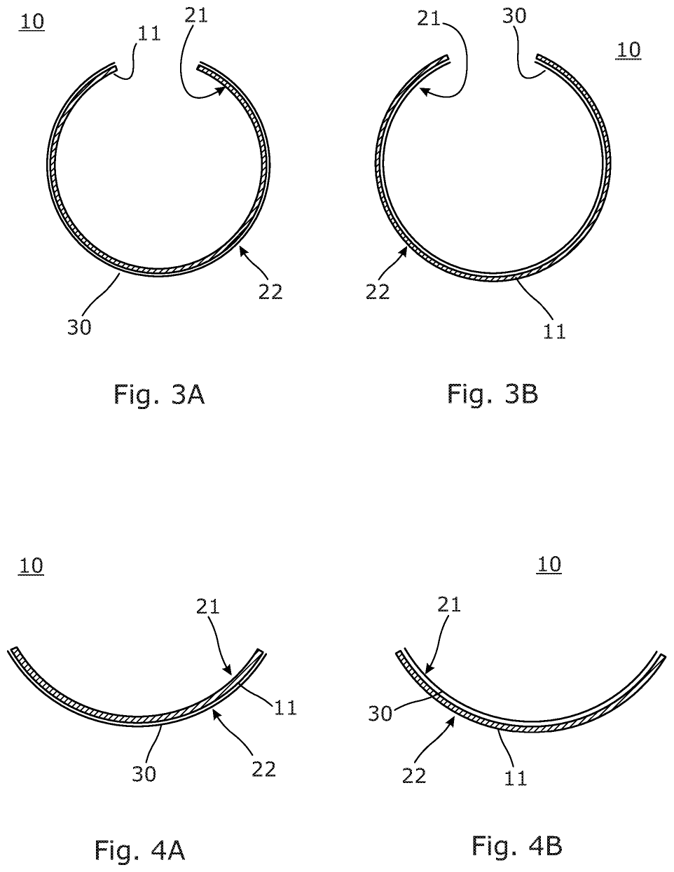

FIG. 3A shows in cross section an example of an extendible member 10 according to the present invention. The member 10 generally has the form of a STEM, as for example shown in isometric projection in FIG. 1. Thus the member 10 comprises a composite shell that can be reversibly reconfigured between a coiled state 11 and an extended state 12. In the extended state 12 the member is generally elongated and biased to have a curved or non-linear cross section in a direction transverse to the longitudinal axis 18 of the member. (References to longitudinal axis or longitudinal extent or direction of extension in this document generally refer to this axis 18). Typically the longitudinal extend of the member 10 is several times the transverse width of the member, e.g. 5 times or 10 times or more. This curvature can be adapted and thus the cross section of the extended portion can comprise anything from a closed or substantially closed circular shape as in the present example to a shallow arc. This gives structural rigidity to the member 10 when extended. In the coiled state 11 the member 10 is generally opened out at the side edges 13 to have a flat cross section, and is coiled around an axis 16 that is transverse to the longitudinal axis 18 of the member 10. The member 10 is thin in cross section to aid coiling, e.g. typically between 0.5 mm and 5 mm for most applications. Preferably, the member 2 is capable of reversible configuration between its coiled and extended forms a plurality of times.

Referring again to FIGS. 3A and 3B, the composite member 10 comprises a layer having a high Poisson's ratio 11 and a highly inextensible layer 30 on one face of the first layer. FIG. 3A shows the inextensible layer 30 on the outside (extrados) face 22 of the slit tube, whereas FIG. 3B shows the inextensible layer 30 on the inside (intrados) face 21 of the slit tube.

FIGS. 4A and 4B show further examples, similar to those of FIGS. 3A and 3B, but with the member 10 having an arcuate cross section which subtends a smaller angle, i.e. a slit tube having a more tape like form.

The effect of using the highly inextensible layer on one face of the coilable member 10 is to move the neutral axis of bending to lie, for all practical purposes, on or very close to this face. As this face no longer extends or contracts to any significant extent on coiling, devices such as OLED flexible lighting panels, or any other object that there may be utility in attaching to a coilable structure, may be bonded to it without experiencing sufficient shear stresses to make the bond fail in in use.

In some cases, it may be possible to use the device intended to be supported during use to provide the inextensible layer in and of itself. For instance, where the device comprises a circuit board, the board can be made highly inextensible, whilst being flexible to allow coiling/uncoiling of the member 10. In other cases, an inextensible layer is provided separately from the device. Where the device or devices are localised along the member, the inextensible layer can be provided either local to the device or devices, or alternatively along a greater extent or the entire length of the member.

The high Poisson's ratio layer may comprise a fibre reinforced polymer (“FRP” hereafter). FRPs are known per se and are not described in detail herein. However, in brief, FRPs are composite materials made of a polymer matrix reinforced with continuous fibres. The fibres are usually fiberglass, carbon, or aramid, while the polymer is usually an epoxy, vinylester or polyester thermosetting plastic. The use of fibrous materials mechanically enhances the strength and elasticity of the plastics. The original plastic material without fibre reinforcement is known as the matrix. The matrix is a tough but relatively weak plastic that is reinforced by stronger stiffer reinforcing filaments or fibres. The extent that strength and elasticity are enhanced in a fibre reinforced plastic depends on the mechanical properties of both the fibre and the matrix, their volume relative to one another, and the fibre length and orientation within the matrix.

The use of FRP allows the mechanical characteristics of the member 10 to be manipulated by varying the weight and direction of fibres in the various layers in such a manner as to produce something that can be tailored to the needs of a specific application. For example, this allows fine tuning of axial/torsional/hoop stiffness to be achieved by, for example, changing the angles and fibre content of the layers.

The layers in the laminar composite may have the fibres run parallel in a particular direction. In others the fibres that are interwoven in some manner, the most common being weaving or braiding the fibres, although knitted fabrics and fabrics that are made from laminar fibres that are linked through the lamina plane by a separate “knot” of fibre are also used.

In the present example, the fibres may be orientated so as to give rise to the high Poisson's ratio, although other techniques for creating a high Poisson's ratio layer are known and may be used.

The composite may be formed by placing lamina of either or both of these types of material one on top of the other, e.g. shaped as a flat plate or a curved shell, and arranging for the resulting stack of fibre materials to be impregnated with a resin, referred to as the matrix, bonding the fibres to form a contiguous solid. Each of these layers is referred to as a ply (or lamina). The sequence of plies is referred to as a lay-up.

The member 10 may be manufactured by taking an existing STEM and bonding the inextensible layer to it as a subsequent step. Alternatively, the inextensible layer may be added to the various plies forming the high Possion's ratio layer and any other layers and laminated together.

The member 10 may alternatively be manufactured by taking the inextensible layer and stretching the high Poisson's ratio layer across its width, i.e. normal to the axis of extension, before bonding it into place. The tension in the high Poisson's ratio layer will then bend the inextensible layer along the axis of extension, forming a device of the type described herein.

The member 10 to be supported may be bonded to the inextensible layer either as part of the manufacturing process, or post bonded using any suitable adhesive or mechanical or other means.

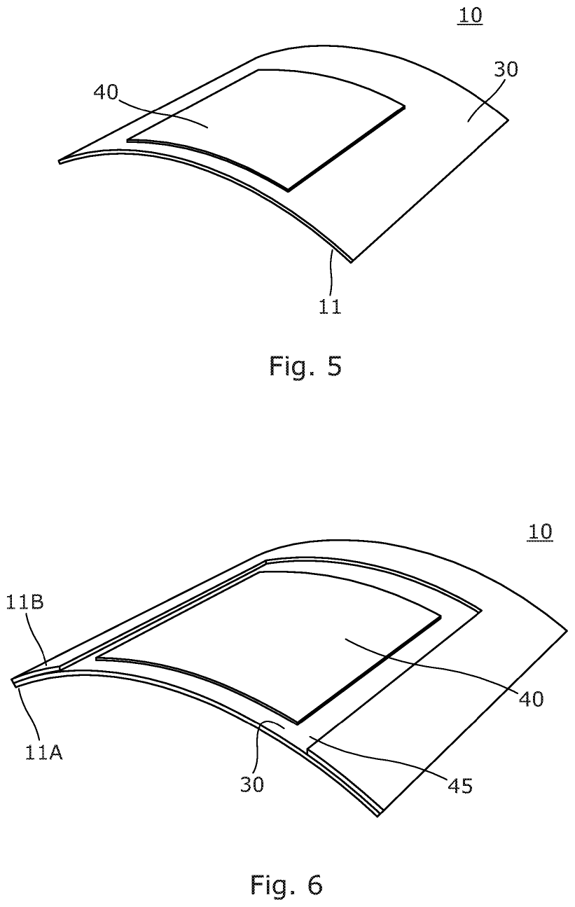

FIG. 5 shows an example of a member 10 so created, where the inextensible layer 30, defining the effective neutral axis, is bonded to a the high Poisson ratio layer 11 and a device 40, such as a flexible OLED lighting panel, is attached to the inextensible layer 30.

If it proves desirable, only part of the inextensible layer may be left exposed, the balance being covered with any highly extensible material, or with another layer of high Poisson ratio material so that the coiling of the member overall is aided by its presence.

FIG. 6 shows a device 10 of this type, where the inextensible layer 30 is formed between first 11A and second 11B high Poisson ratio layers. An area of the second layer 11B is removed to provide a window 45 to an area of the inextensible layer 30 to mount the device 40, which in this example is an OLED light, display screen or any other such device, that the whole structure is designed to carry or deploy.

In all cases the inner or outer surfaces may be used to provide the inextensible layer and thus be suitable for bonding to. Thus, the device can be positioned to face outwards from the inner or outer surface of the extended member.

In addition to being able to provide a light, display or other device that can be coiled for storage or transport, this type of structure may prove of particular use when partially deployed, or when folded one or more times along the length whilst in use.

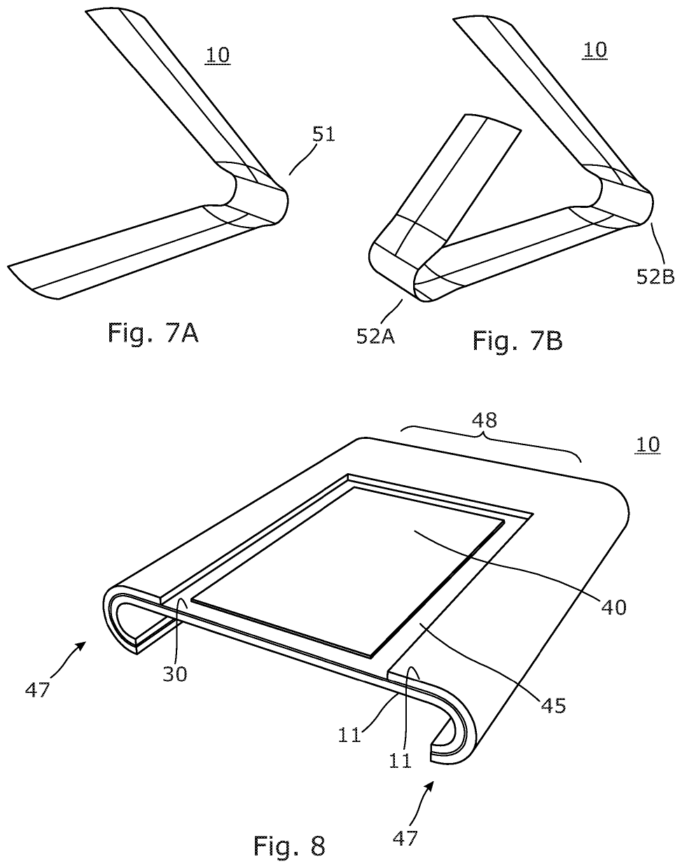

FIGS. 7A and 7B shows this type of deployment. FIG. 7A shows a member 10 having a deployment with a single fold 51 and FIG. 7B shows a member 10 having a deployment with a double fold 52A,52B at spaced positions along the length of the extended member. By controlling the elasticity, tensile modulus and Poisson's ratio of the high Poisson's ratio layer or layers these folds can be made such as to be stable in use, allowing a wide variety of deployed configurations to be achieved. A BRC will exhibit this type of stable folded behaviour when the damping effects exhibited by the viscosity of the matrix polymer are sufficient to overcome the forces derived from classical spring behaviour acting to restore the original geometry. This type of behaviour could prove of use in a number of applications, where, for example, it may be desirable to form a temporary hook at one end of the BRC device or to form it into a geometry allowing one section of it to form a stand.

Putting a light emitting device, such as a flexible OLED onto the intrados surface of the member 10 will give rise to a reflector type of light fixture, concentrating the light on the intrados side. Putting it on the extrados face of the extended member 10 will produce a more generally distributed light, with devices in which the arc subtended by the deployed structure approaches, equals or exceeds 360 degrees able to provide a full circular coverage.

The member 10 may be made such as to be translucent or transparent, allowing some OLED devices that can emit light from both faces to illuminate both intrados and extrados faces.

It is not necessary for the whole of the extended sectional profile of the member 10 to have a resting curvature. FIG. 8 shows an implementation similar to that shown in FIG. 6 but where the area of the inextensible layer to which the device 40 to be carried is bonded is flat. This area will not produce any bi-stable behaviour, regardless of the nature of the materials bonded to it but the whole can be rolled integrally with the curved edges 47 providing the tendency to coil and transmitting this to the central, flat portion 48. It is key in this type of implementation that the central, flat portion is weak enough in bending that the Poisson's ratio derived forces acting from the curved edges 47 can force it into a coil 14.

In all implementations of this type electrical cables, optical fibres or any other means of connection may be integrated into the structure of the device. Similarly multiple devices, for example: an OLED lighting panel, a flexible display screen a flexible battery and a flexible PCB carrying control circuitry for the display and light may be integrated into the same overall structure, and connected to each other.

Embodiments of the present invention have been described with particular reference to the example illustrated. However, it will be appreciated that variations and modifications may be made to the examples described within the scope of the present claims.

1. A member comprising:
a first layer or layers exhibiting a high Poisson's ratio;
an inextensible layer fixed to the first layer or layers; and
a device fixed to or incorporating the inextensible layer,
wherein the member when extended from a coiled form is resiliently biased in a form having a curved cross section transverse to the direction of extension.

2. The member according to claim 1, wherein the device is a flexible display screen, lighting panel, or circuit board.

3. The member according to claim 1, wherein the first layer or layers comprises a fibre reinforced composite with fibres angled to the axis of extension of the member.

4. The member according to claim 1, wherein the inextensible layer is inextensible in one direction.

5. The member according to claim 1, wherein the member is inextensible in both, orthogonal surface directions.

6. The member according to claim 1, wherein a flexible layer or second high Poisson's ratio layer or layers are bonded to the inextensible sheet on the opposite side to the first layer.

7. The member according to claim 6, wherein the flexible layer or second high Poisson's ratio layer or layers has a cut out to accommodate the device.

8. The member according to claim 1, wherein the member comprises at least one translucent layer and the device is a light emitting device such that when extended, in use, light is visible external to the member through the translucent layer or layers on the intrados and/or extrados face of the member.

9. The member according to claim 1, wherein the member in extended form is configured to form a stable bend at one or more points along its length.

10. The member according to claim 1, wherein the extended member in cross section has at least one flat portion adjacent at least one curved portion, wherein the device only extends across the flat portion.

11. The method of deploying a device, using a member according to claim 1, the method comprising:
uncoiling the member; and
positioning the member.

12. The method according to claim 11, wherein the device comprises an electrical display, the method comprising, connecting a connector of the member to an external control device, computing device or power source.

13. The method according to claim 11, comprising forming a bend in the uncoiled member.

14. A method of manufacturing a member, comprising laminating:
a first layer or layers exhibiting a high Poisson's ratio;
an inextensible layer fixed to the first layer or layers; and
a device fixed to or incorporating the inextensible layer,
wherein the member when extended from a coiled form is resiliently biased in a form having a curved cross section transverse to the direction of extension.

15. The method according to claim 14, comprising tensioning the high Poisson's ratio layer across its width, normal to the axis of extension, before laminating it to the inextensible layer such that the tension in the high Poisson's ratio layer will then bend the inextensible layer along the axis of extension.

16. The method according to claim 11, comprising laminating the first layer or layers to the inextensible layer before bonding the device to the rest of the member.

17. The member according to claim 1, wherein the first layer or layers comprise a laminate of at least one fibre reinforced layer, having fibres angled to the extension direction.

18. A member comprising:
a first layer or layers exhibiting a high Poisson's ratio; and
an inextensible layer fixed to the first layer or layers;
wherein the member when extended from a coiled form is resiliently biased in a form having a curved cross section transverse to the direction of extension and wherein the member in extended form is configured to form a stable bend at one or more points along its length.
